(19) United States
(12) Patent Application Publication
(10) Pub. No.: US 2026/0117878 A1
(43) Pub. Date: Apr. 30, 2026

(54) VALVE BODY STRUCTURE OF A VALVE DEVICE FOR A WEATHER-SEALING CHECK VALVE AND METHOD THEREFOR

(71) Applicant: Knorr-Bremse AG, München (DE)

(72) Inventor: Miguel Angel Camacho Alcalá, Nuevo Leon (MX)

(21) Appl. No.: 18/931,245

(22) Filed: Oct. 30, 2024

(51) Int. Cl. F16K 15/14

(52) U.S. Cl. CPC F16K 15/148

(57) ABSTRACT

A valve body structure of a valve device comprises a sealing surface, and a venting surface defining a ventilation relief opening through which air can flow from inside of the valve device to outside of the valve device. The valve body structure also comprises a number of retaining surfaces positioned between the sealing surface and the venting surface. The retaining surfaces cooperate together to (i) secure in place a rubber washer that allows air from inside of the valve device to flow around the rubber washer to outside of the valve device when air is flowing through the ventilation relief opening from inside of the valve device to outside of the valve device, and (ii) prevents debris from outside of the valve device from reaching the ventilation relief opening.

### BACKGROUND

The present application relates to weather-sealing check valves of valve devices, and is particularly directed to a valve body structure of a valve device for a weather-sealing check valve and method therefor.

A typical weather-sealing check valve of a valve device allows air to flow in only one direction from inside of the valve device to outside of the valve device. Pressure of the flowing air moves the check valve from a closed position to an open position to allow the air to flow through the check valve from inside of the valve device to outside of the valve device. When in its closed position, the check valve prevents debris from outside of the valve device to flow through the check valve from outside of the valve device to inside of the valve device.

Despite advances already made, those skilled in the art continue with research and development efforts in the field of weather-sealing check valves of valve devices.

### SUMMARY

In accordance with one example embodiment, a valve body structure of a valve device comprises a sealing surface, and a venting surface defining a ventilation relief opening through which air can flow from inside of the valve device to outside of the valve device. The valve body structure also comprises a number of retaining surfaces positioned between the sealing surface and the venting surface. The retaining surfaces cooperate together to (i) secure in place a rubber washer that allows air from inside of the valve device to flow around the rubber washer to outside of the valve device when air is flowing through the ventilation relief opening from inside of the valve device to outside of the valve device, and (ii) prevents debris from outside of the valve device from reaching the ventilation relief opening.

In accordance with another example embodiment, a valve body structure of a valve device is provided for enabling a rubber washer to function as a weather-sealing check valve. The valve body structure comprises a sealing surface. The valve body structure also comprises a non-threaded portion arranged to allow an outer perimeter surface of the rubber washer to resiliently engage the sealing surface without using fasteners and thereby to enable the rubber washer to function as a weather-sealing check valve.

In accordance with yet another example embodiment, a valve body structure of a valve device comprises a venting surface lying in a first plane and defining a ventilation relief opening through which air can flow from inside of the valve device to outside of the valve device. The valve body structure also comprises a sealing surface lying in a second plane that is substantially parallel to the first plane. The valve body structure further comprises a first retaining surface lying in a third plane that lies between the first and second planes and is substantially parallel to the first and second planes, wherein the first retaining surface and the sealing surface cooperate together to secure in place a rubber washer.

In accordance with still another example embodiment, a method is provided of securing a rubber washer to a valve body structure of a valve device to provide a weather-sealing check valve. The method comprises stretching the rubber washer in vicinity of a central opening of the rubber washer to allow the rubber washer in the vicinity of the central opening to be wrapped around a retaining portion of the valve body structure. The method also comprises manipulating the stretched rubber washer to allow the rubber washer to snap-in place around the retaining portion of the valve body structure to secure in place the rubber washer and thereby to provide the weather-sealing check valve in which air can flow in only one direction from inside of the valve device to outside of the valve device.

### BRIEF DESCRIPTION OF THE DRAWINGS

FIG. 1 is a perspective view of a valve device embodying a prior art valve body structure.

FIG. 1A is an enlarged view of a portion of the valve device of FIG. 1, which is designated with circle “1A” in FIG. 1.

FIG. 2A is a view similar to FIG. 1A, and shows a valve device embodying a weather-sealing check valve secured to a valve body structure that is constructed in accordance with the present disclosure.

FIG. 2B is a view similar to FIG. 2A, taken approximately along line “2B-2B” in FIG. 2A, and shows a portion of a rubber washer sectioned away to better illustrate the valve body structure.

FIG. 2C is a view similar to FIG. 2A, and shows a rubber washer completely removed to better illustrate a valve body structure.

FIG. 2D is a sectional view, taken approximately along line “2D-2D” in FIG. 2B.

FIG. 2E is an enlarged view of a portion of the valve body structure of FIG. 2D, which is designated with circle “2E” in FIG. 2D.

FIG. 3 is a flow diagram depicting a method of securing a rubber washer to a valve body structure to provide a weather-sealing check valve in accordance with the present disclosure.

### DETAILED DESCRIPTION

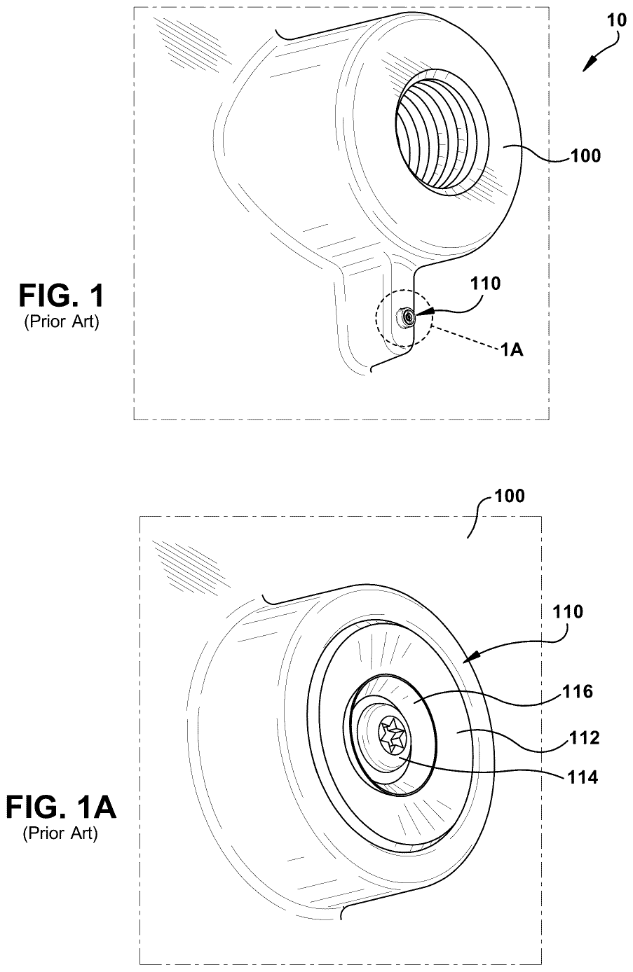

Referring to FIG. 1, a perspective view of a valve device 10 embodying a prior art valve body structure 100 in accordance with an embodiment is illustrated. An enlarged view of a portion 110 of the valve device 10 of FIG. 1, which is designated with circle “1A” in FIG. 1, is illustrated in FIG. 1A.

The portion 110 of the valve device 10 is a weather-sealing check valve. The check valve 110 includes a rubber washer 112 that is secured to a threaded portion (not shown) of the valve body structure 100 using a screw 114 and metal washer 116. The screw 114 is tightened into the threaded portion of the valve body structure 100. The screw 114 presses the metal washer 116 against the rubber washer 112 which, in turn, presses the rubber washer 112 against the valve body structure 100 to secure in place the rubber washer 112 relative to the valve body structure 100.

The rubber washer 112 of the check valve 110 moves from a closed position (as shown in FIG. 1A) to an open position (not shown) to allow air to flow from inside of the valve device 10 to outside of the valve device 10 when the pressure of air inside of the valve device 10 exceeds a predetermined air pressure. When the rubber washer 112 is in the closed position, outside debris is prevented from flowing from outside of the valve device 10 to inside of the valve device 10. Operation of the weather-sealing check valve 110 is known and conventional and, therefore, will not be described.

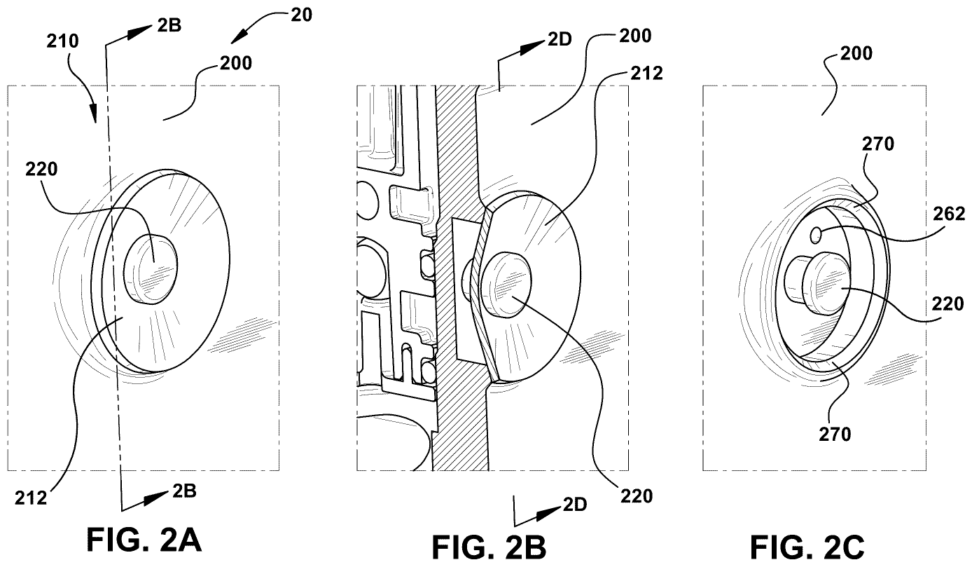

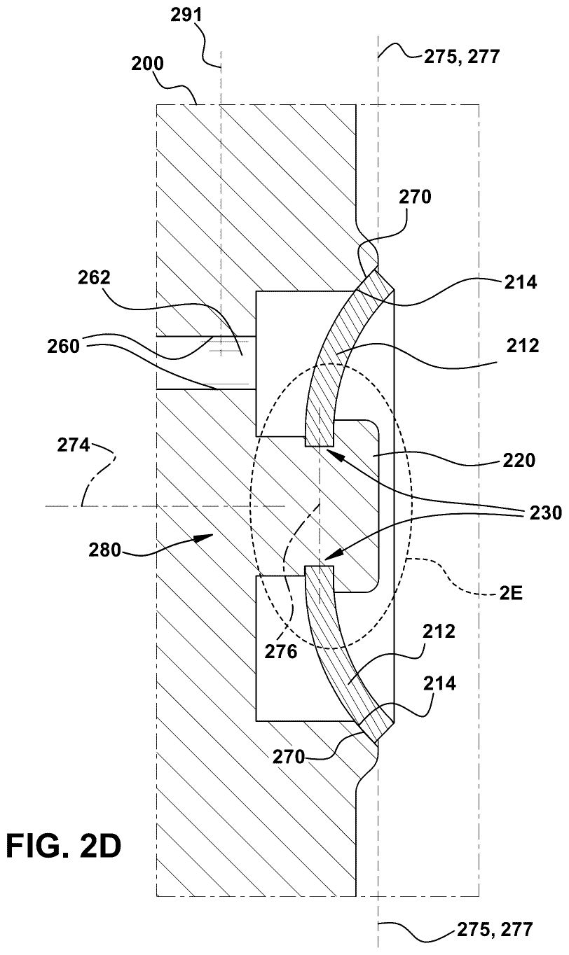

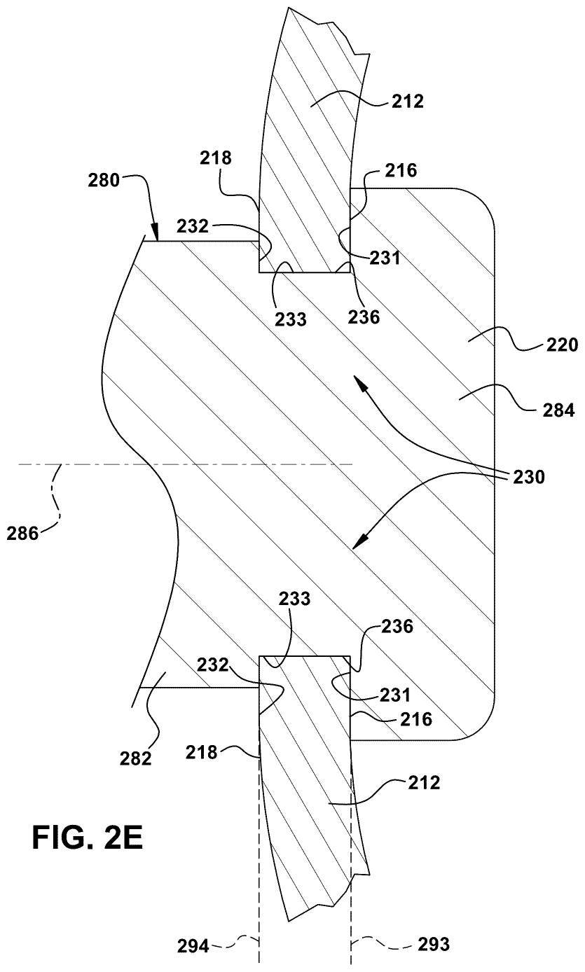

Referring to FIG. 2A (which is similar to FIG. 1A), a valve device 20 embodying a weather-sealing check valve 210 secured to a valve body structure 200 that is constructed in accordance with the present disclosure is illustrated. The check valve 210 includes a rubber washer 212 that is secured to a retaining portion 220 of a valve body structure 200. The retaining portion 220 secures in place the rubber washer 212 relative to the valve body structure 200 without using any fasteners such as screws.

FIG. 2B is a view similar to FIG. 2A, taken approximately along line “2B-2B” in FIG. 2A. FIG. 2B shows a portion of the rubber washer 212 sectioned away to better illustrate the valve body structure 200. Further, referring to FIG. 2C (which is also similar to FIG. 2A), the rubber washer 212 is completely removed to better illustrate the valve body structure 200. FIG. 2D is a sectional view, taken approximately along line “2D-2D” in FIG. 2B.

As best shown in FIG. 2D, the valve body structure 200 includes a sealing surface 270 against which an outer perimeter surface 214 of the rubber washer 212 resiliently engages. The valve body structure 200 also includes a circumferential venting surface 260 that defines a ventilation relief opening 262 through which air can flow from inside of the valve device 20 to outside of the valve device 20. The valve body structure 200 includes a number of retaining surfaces 230 that are positioned between the sealing surface 270 and the venting surface 260.

Referring to FIG. 2E, an enlarged view of a portion of the valve body structure 200 of FIG. 2D, which is designated with circle “2E” in FIG. 2D, is illustrated. The number of retaining surfaces 230 includes a first retaining surface 231 that engages an inner perimeter surface 216 on one major side surface of the rubber washer 212, and a second retaining surface 232 that engages an inner perimeter surface 218 on an opposite major side surface of the rubber washer 212. The first retaining surface 231 comprises a first planar surface 231, and the second retaining surface 232 comprises a second planar surface 232 that is substantially parallel to the first planar surface 231.

The number of retaining surfaces 230 also includes a third retaining surface 233 comprising a third planar surface 233 that extends transverse to the first and second planar surfaces 231, 232 to form a U-shaped groove 236 in which the inner perimeter surfaces 216, 218 of the rubber washer 212 are disposed such that the inner perimeter surfaces 216, 218 resiliently engage the first and second planar surfaces 231, 232 to provide an interference fit that secures in place the rubber washer 212.

The retaining surfaces 231, 232, 233 cooperate together to secure in place the rubber washer 212 that allows air from inside of the valve device 20 to flow around the rubber washer 212 (i.e., the rubber washer 212 is in an open position) to outside of the valve device 20 when air is flowing through the ventilation relief opening 262 (FIG. 2D) from inside of the valve device 20 to outside of the valve device 20. The rubber washer 212 in a closed position prevents debris from outside of the valve device 20 from reaching the ventilation relief opening 262. The sealing surface 270 (FIG. 2D) is against which the outer perimeter surface 214 of the rubber washer 212 engages when the inner perimeter surfaces 216, 218 (FIG. 2E) of the rubber washer 212 are resiliently engaging the first and second planar surfaces 231, 232 to provide the interference fit that secures in place the rubber washer 212.

In accordance with an aspect of the present disclosure, the valve body structure 200 enables the rubber washer 212 to function as a one-way diaphragm check valve without using fasteners to secure in place the rubber washer 212. Notably, the valve body structure 200 comprises the sealing surface 270 (FIG. 2D) and a non-threaded portion 280 (shown in both FIGS. 2D and 2E) that is arranged to allow the outer perimeter surface 214 of the rubber washer 212 to resiliently engage the sealing surface 270 without using fasteners. The rubber washer 212 is thereby enabled to function as a one-way diaphragm check valve.

The non-threaded portion 280 includes a post portion 282 (FIG. 2E) and a cross portion 284 that extends perpendicular to the post portion 282 to form a T-shape. The post portion 282 has the U-shaped groove 236 (which extends circumferentially around the post portion 282) in which the inner perimeter surfaces 216, 218 of the rubber washer 212 resiliently engage to provide the interference fit that secures in place the rubber washer 212.

The sealing surface 270 is a circumferential sealing surface (FIG. 2D) having a longitudinal central axis 274. The circumferential sealing surface 270 lies in an outer plane 275, and the circumferential U-shaped groove 236 lies in an inner plane 276 that is parallel to the outer plane 275 and offset from the outer plane 275 such that the outer perimeter surface 214 of the rubber washer 212 resiliently engages the circumferential sealing surface 270 when the inner perimeter surfaces 216, 218 are interference-fitted in the circumferential U-shaped groove 236. The post portion 282 has a longitudinal central axis 286 (FIG. 2E) that is concentric with the longitudinal central axis 274 (FIG. 2D) of the circumferential scaling surface 270.

In accordance with another aspect of the present disclosure, the venting surface 260 lies in a first plane 291 (FIG. 2D) and defines the ventilation relief opening 262 through which air can flow from inside of the valve device 20 to outside of the valve device 20. The sealing surface 270 lies in a second plane 277 that is the same as the outer plane 275 previously described. The second plane 277 is substantially parallel to the first plane 291. The first retaining surface 231 (FIG. 2E) lies in a third plane 293 that lies between the first and second planes 291, 277 (FIG. 2D) and is substantially parallel to the first and second planes 291, 277.

The second retaining surface 232 lies in a fourth plane 294 (FIG. 2E) that lies adjacent the third plane 293 and between the first and second planes 291, 277 and is substantially parallel to the first and second planes 291, 277. The first and second retaining surfaces 231, 232 define at least in part the U-shaped groove 236 in which a portion of the rubber washer 212 is disposed to secure in place the inner perimeter surfaces 216, 218 of the rubber washer 212. In particular, the first and second retaining surfaces 231, 232 cooperate together to provide the interference fit that secures in place an inner diameter portion of the rubber washer 212.

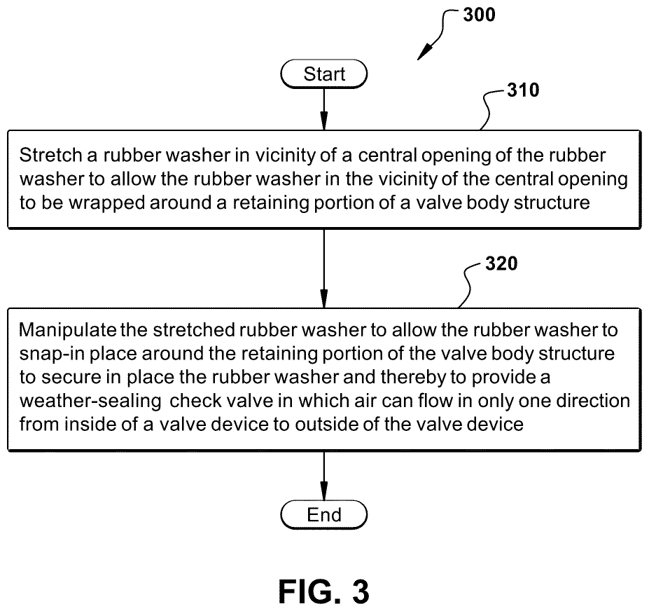

Referring to FIG. 3, a flow diagram 300 depicts a method of securing a rubber washer to a valve body structure to provide a weather-sealing check valve.

In block 310, the rubber washer in vicinity of a central opening of the rubber washer is stretched to allow the rubber washer in the vicinity of the central opening to be wrapped around a retaining portion of the valve body structure. The process proceeds to block 320 in which the stretched rubber washer is manipulated to allow the rubber washer to snap-in place around the retaining portion of the valve body structure to secure in place the rubber washer. The weather-sealing check valve is thereby provided in which air can flow in only one direction from inside of the valve device to outside of the valve device. The process then ends.

In some embodiments, the rubber washer in vicinity of a central opening of the rubber washer is stretched to allow the rubber washer in the vicinity of the central opening to be wrapped around a non-threaded retaining portion of the valve body.

In some embodiments, the snapped-in place rubber washer is released to allow an outer perimeter surface of the rubber washer to resiliently engage a sealing surface of the valve body structure such that air flows through a gap between the sealing surface and the outer perimeter surface when air is flowing in the only one direction from inside of the valve device to outside of the valve device.

A number of advantages are provided by securing the rubber washer 212 to the non-threaded portion 280 of the valve body structure 200 as described hereinabove. One advantage is that a self-retention mechanism is provided to secure in place the rubber washer 212, without having the need for fastening hardware such as screws. The result is less material costs.

Another advantage is that less labor time is needed to either install a new production rubber washer or replace an old rubber washer since no fastening hardware is used and the rubber washer 212 is simply snapped into place to secure the rubber washer 212. The result is less labor costs.

While the present disclosure has been illustrated by the description of example processes and system components, and while the various processes and components have been described in detail, applicant does not intend to restrict or in any way limit the scope of the appended claims to such detail. Additional modifications will also readily appear to those skilled in the art. The disclosure in its broadest aspects is therefore not limited to the specific details, implementations, or illustrative examples shown and described. Accordingly, departures may be made from such details without departing from the spirit or scope of applicant's general concept.

What is claimed is:

1. A valve body structure of a valve device comprising:
a sealing surface;
a venting surface defining a ventilation relief opening through which air can flow from inside of the valve device to outside of the valve device; and
a number of retaining surfaces positioned between the sealing surface and the venting surface, wherein the retaining surfaces cooperate together to (i) secure in place a rubber washer that allows air from inside of the valve device to flow around the rubber washer to outside of the valve device when air is flowing through the ventilation relief opening from inside of the valve device to outside of the valve device, and (ii) prevents debris from outside of the valve device from reaching the ventilation relief opening.

2. A valve body structure according to claim 1, wherein the number of retaining surfaces includes (i) a first retaining surface that engages an inner perimeter surface on one major side surface of the rubber washer, and (ii) a second retaining surface that engages an inner perimeter surface on an opposite major side surface of the rubber washer.

3. A valve body structure according to claim 2, wherein the first retaining surface comprises a first planar surface, and the second retaining surface comprises a second planar surface that is substantially parallel to the first planar surface.

4. A valve body structure according to claim 3 further comprising:
a third retaining surface comprising a third planar surface that extends transverse to the first and second planar surfaces to form a U-shaped groove in which the inner perimeter surfaces of the rubber washer are disposed such that the inner perimeter surfaces resiliently engage the first and second planar surfaces to provide an interference fit that secures in place the rubber washer.

5. A valve body structure according to claim 4, wherein the sealing face resiliently engages an outer perimeter surface of the rubber washer when the inner perimeter surfaces of the rubber washer are resiliently engaging the first and second planar surfaces to provide the interference fit that secures in place the rubber washer.

6. A valve body structure of a valve device for enabling a rubber washer to function as a weather-sealing check valve, the valve body structure comprising:
a sealing surface; and
a non-threaded portion arranged to allow an outer perimeter surface of the rubber washer to resiliently engage the sealing surface without using fasteners and thereby to enable the rubber washer to function as a weather-sealing check valve.

7. A valve body structure according to claim 6, wherein the non-threaded portion includes a post portion and a cross portion that extends perpendicular to the post portion to form a T-shape.

8. A valve body structure according to claim 7, wherein the post portion has a circumferential U-shaped groove in which an inner perimeter surface of the rubber washer resiliently engages to provide an interference fit that secures in place the rubber washer.

9. A valve body structure according to claim 8, wherein the sealing surface comprises a circumferential sealing surface having a longitudinal central axis.

10. A valve body structure according to claim 9, wherein (i) the circumferential sealing surface lies in an outer plane, and (ii) the circumferential U-shaped groove lies in an inner plane that is substantially parallel to the outer plane and offset from the outer plane such that the circumferential sealing surface resiliently engages the outer perimeter surface of the rubber washer when the inner perimeter surface is interference-fitted in the circumferential U-shaped groove.

11. A valve body structure according to claim 9, wherein the post portion has a longitudinal central axis that is concentric with the longitudinal central axis of the circumferential sealing surface.

12. A valve body structure of a valve device comprising:
a venting surface lying in a first plane and defining a ventilation relief opening through which air can flow from inside of the valve device to outside of the valve device;
a sealing surface lying in a second plane that is substantially parallel to the first plane; and
a first retaining surface lying in a third plane that lies between the first and second planes and is substantially parallel to the first and second planes, wherein the first retaining surface and the sealing surface cooperate together to secure in place a rubber washer.

13. A valve body structure according to claim 12 further comprising:
a second retaining surface lying in a fourth plane that lies adjacent the third plane and between the first and second planes and is substantially parallel to the first and second planes.

14. A valve body structure according to claim 13, wherein the first and second retaining surfaces define at least in part a U-shaped groove in which a portion of the rubber washer is disposed to secure in place an inner diameter portion of the rubber washer.

15. A valve body structure according to claim 13, wherein the first and second retaining surfaces cooperate together to provide an interference fit that secures in place an inner diameter portion of the rubber washer.

16. A valve body structure according to claim 13, wherein (i) the first and second retaining surfaces define at least in part a U-shaped groove in which a portion of the rubber washer is disposed, and (ii) the first and second retaining surfaces cooperate together to provide an interference fit that secures in place an inner diameter portion of the rubber washer.

17. A method of securing a rubber washer to a valve body structure of a valve device to provide a weather-sealing check valve, the method comprising:
stretching the rubber washer in vicinity of a central opening of the rubber washer to allow the rubber washer in the vicinity of the central opening to be wrapped around a retaining portion of the valve body structure; and
manipulating the stretched rubber washer to allow the rubber washer to snap-in place around the retaining portion of the valve body structure to secure in place the rubber washer and thereby to provide the weather-sealing check valve in which air can flow in only one direction from inside of the valve device to outside of the valve device.

18. A method according to claim 17, wherein stretching the rubber washer in vicinity of a central opening of the rubber washer to allow the rubber washer in the vicinity of the central opening to be wrapped around a retaining portion of the valve body structure includes:
stretching the rubber washer in vicinity of a central opening of the rubber washer to allow the rubber washer in the vicinity of the central opening to be wrapped around a non-threaded retaining portion of the valve body structure.

19. A method according to claim 17 further comprising:
releasing the snapped-in place rubber washer to allow an outer perimeter surface of the rubber washer to resiliently engage a sealing surface of the valve body structure such that air flows through a gap between the sealing surface and the outer perimeter surface when air is flowing in the only one direction from inside of the valve device to outside of the valve device.
